(19) United States
(12) Patent Application Publication
(10) Pub. No.: US 2023/0045551 A1
(43) Pub. Date: Feb. 9, 2023

(54) Decking Systems and Accessories

(71) Applicant: Michael John Holmes, Bolingbrook, IL (US)

(72) Inventor: Michael John Holmes, Bolingbrook, IL (US)

(21) Appl. No.: 17/872,495

(22) Filed: Jul. 25, 2022

Related U.S. Application Data
(60) Provisional application No. 63/254,143, filed on Oct. 10, 2021.
(60) Provisional application No. 63/224,852, filed on Jul. 23, 2021.

(51) Int. Cl. E04F 15/02; E04F 13/08; F16B 45/00; F21S 4/28; F21V 5/04

(52) U.S. Cl. CPC E04F 15/02044; E04F 13/0846; F16B 45/002; F21S 4/28; F21V 5/04; E04F 2015/02122; E04F 2290/026

(57) ABSTRACT

A deck system can include a first deck board; a second deck board; an accent strip; and/or a deck clip. In some embodiments, the first deck board and the second deck board are slotted to receive the deck clip. In some embodiments, the deck clip has a hole configured to receive a screw to attach the deck clip to a wall. In some embodiments, the accent strip is made of aluminum and/or vinyl. A deck anchor system can include a deck anchor, a bungee cord, a rope, and/or a corresponding hook. In some embodiments, the deck anchor includes a tightening handle; a blade; an eye hook; a shaft, a pinch bar; and/or a cam lever. In some embodiments, the shaft is threaded. In some embodiments, the pinch bar is curved. In some embodiments, an end of pinch bar is covered in rubber.

### CROSS-REFERENCE TO RELATED APPLICATION(S)

This application is related to and claims priority benefits from U.S. Provisional Patent Application Ser. No. 63/224,852 having a filing date of Jul. 23, 2021, entitled “Decking Systems and Accessories”. This application is also related to and claims priority benefits from U.S. Provisional Patent Application Ser. No. 63/254,143 having a filing date of Oct. 10, 2021, also entitled “Decking Systems and Accessories”.

The '852 and '143 applications are hereby incorporated by reference herein in their entireties.

### FIELD OF THE INVENTION

The present invention relates to decking systems and various accessories to be used with decking systems. In particular, the invention relates to accent strips and ways of installing the accent strips with new or existing decking systems. The invention also relates to various decking accessories and methods of using said decking accessories to anchor various items, such as tarps, furniture, and/or grills to a deck. This can be advantageous, particularly in keeping furniture and/or grills in place during periods of strong winds. This can also be advantageous if one wants to tie a tarp over the furniture/grills when they are not in use and/or during winter months.

### SUMMARY OF THE INVENTION

A deck system can include a first deck board; a second deck board; an accent strip; and/or a deck clip. In some embodiments, the first deck board and the second deck board are slotted to receive the deck clip. In some embodiments, the deck clip has a hole configured to receive a screw to attach the deck clip to a wall. In some embodiments, the accent strip is made of aluminum and/or vinyl. In some embodiments, the accent strip incorporates lights.

A deck anchor system can include a deck anchor, a bungee cord, a rope, and/or a corresponding hook.

In some embodiments, the deck anchor includes a tightening handle; a blade; an eye hook; a shaft, a pinch bar; and/or a cam lever. In some embodiments, the shaft is threaded. In some embodiments, the pinch bar is curved. In some embodiments, an end of the pinch bar is covered in rubber.

### BRIEF DESCRIPTION OF THE DRAWINGS

FIG. 1 is a front view of a wall system utilizing accent strips and deck boards.

FIG. 2 is a side cutaway view of a wall system utilizing accent strips.

FIG. 3 is a perspective cutaway view of a wall system utilizing accent strips.

FIG. 4 is a perspective view of a deck clip.

FIG. 5 is a front cutaway view of a deck clip.

FIG. 6 is a top view of a deck clip.

FIG. 7 is a side cutaway view of a deck clip.

FIG. 8 is a front cutaway view of a track strip.

FIG. 9 is a perspective view of a track strip.

FIG. 10 is a front view of an accent trim strip.

FIG. 11 is a front cutaway view of an accent trim strip attached to a track strip.

FIG. 12 is a front view of a lens strip.

FIG. 13 is a front cutaway view of a lens strip attached to a track strip.

FIG. 14 is a front view of an eyehook deck anchor.

FIG. 15 is a side view of an eyehook deck anchor.

FIG. 16 is a front view of an eyehook deck anchor with a deck anchor handle attached.

FIG. 17A is a front view of a deck anchor handle.

FIG. 17B is a top view of a deck anchor handle.

FIG. 17C is a side view of a deck anchor handle.

FIG. 18 is a side partial cutaway view of a deck anchor handle.

FIG. 19 is a perspective view of an eyehook deck anchor with a deck anchor handle attached.

FIG. 20 is a front cutaway view of an eyehook deck anchor attached to a deck.

FIG. 21A is a side view of a clamp deck anchor.

FIG. 21B is a front view of a clamp deck anchor.

FIG. 22 is a side cutaway view of a clamp deck anchor stabilizing a piece of furniture.

FIG. 23A is a side view of a cam lever.

FIG. 23B is a top view of a cam lever.

FIG. 24A is a top view of a pinch bar.

FIG. 24B is a side view of a pinch bar.

FIG. 25 is a side cutaway view of an eyehook deck anchor attached to a rope.

FIG. 26 is a side cutaway view of an eyehook deck anchor attached to a hook.

FIG. 27A is a side view of a light fixture configured to be utilized in a wall system.

FIG. 27B is a front view of a light fixture configured to be utilized in a wall system.

FIG. 28 is a side cutaway view of a light fixture being utilized in a wall system.

### DETAILED DESCRIPTION OF ILLUSTRATIVE EMBODIMENT(S)

Deck System with Accent Strip(s)

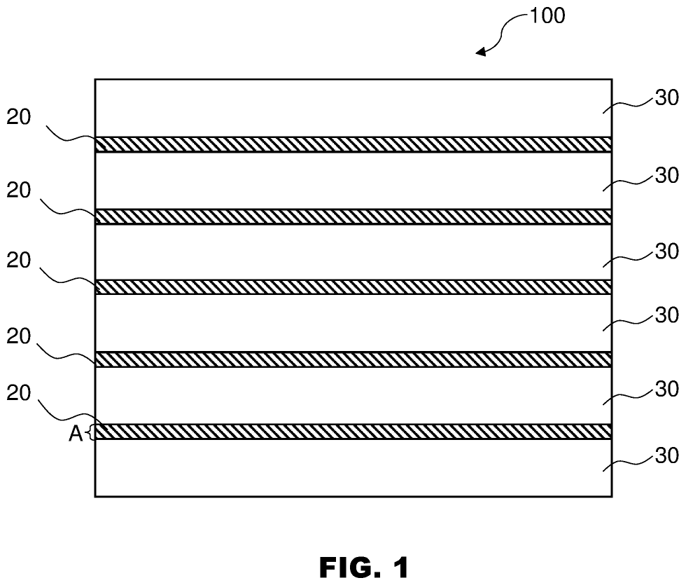

FIG. 1 is a front view of deck system 100 with accent strips 20 in between deck boards 30. In some embodiments, deck boards 30 include slots 35 configured to receive deck clip 10. In some embodiments, deck clip 10 includes screw hole 12 configured to receive screw 22 to attach deck clip 10 to a wall. In some embodiments, deck clip 10 can be glued to a wall. In some embodiments, deck clip 10 is magnetic to aid in attaching accent strip 20 and/or attaching deck clip 10 to a wall.

In some embodiments, deck system 100 can be laid as a floor. In some embodiments, deck system 100 is used to create a railing wall, a privacy wall, a deck apron, a dividing structure, and/or planters.

In some embodiments, accent strip 20 is made of aluminum. In some embodiments, accent strip 20 is made of 26-gauge aluminum stock. In some embodiments, accent strip 20 is made of, among other materials, vinyl, plastics, polyvinyl chloride, plexiglass, or acrylics.

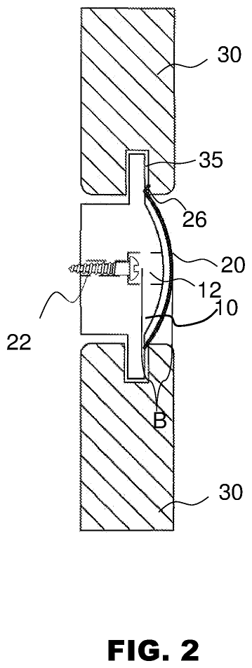

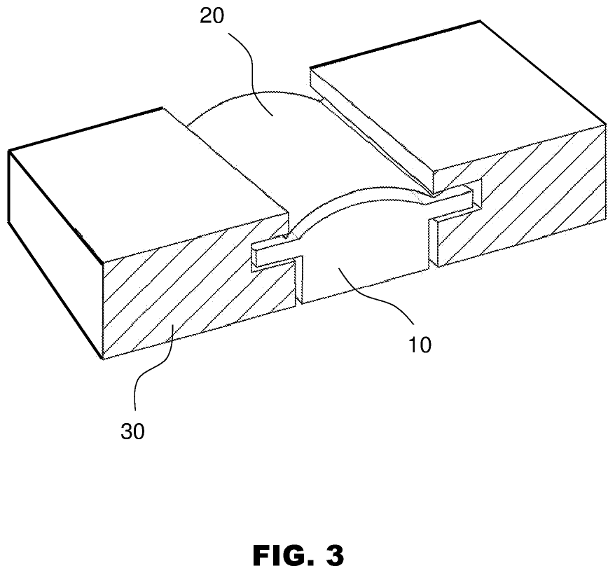

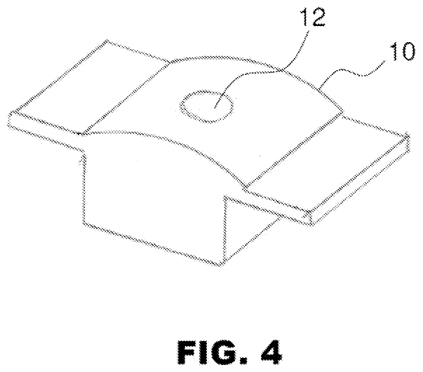

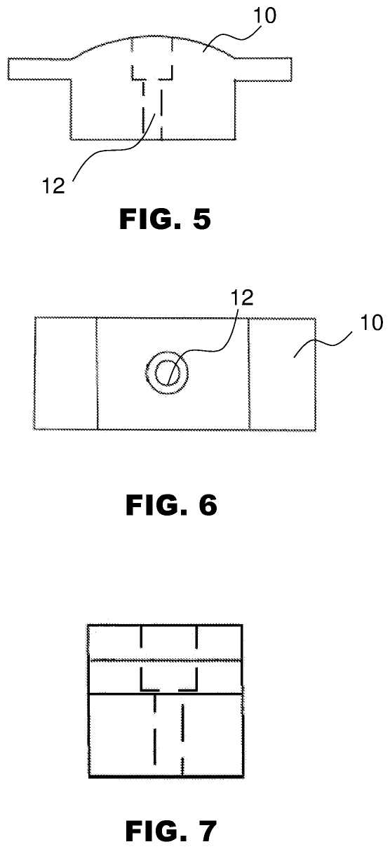

In some embodiments, accent strip 20 is lighted. In some embodiments, accent strip 20 is made of a semi flexible material that is capable of forming a convex shape such as shown in FIG. 2. In some embodiments, such as the one shown in FIG. 2, accent strip 20 has bend 26 configured to lock accent strip 20 into place. In some embodiments, bend 26 is approximately 0.125 inches (3.175 mm). In some embodiments, bend 26 is between 0.1 and 0.2 inches (2.54 to 5.08 mm).

In some embodiments, accent strip 20 has a width A of approximately 1 to 2.5 inches (25.4 to 63.5 mm). In some embodiments, accent strip 20 has a width A of approximately 1.75 inches (44.45 mm). In some embodiments, accent strip 20 has a depth B of approximately 0.25 inches (6.35 mm).

In some embodiments, deck system 100 includes at least one accent strip 20. In some embodiments, deck system 100 includes two accent strips 20. In some embodiments, deck system 100 includes three accent strips 20. In some embodiments, deck system 100 includes four accent strips 20. In some embodiments with multiple accent strips 20, the accent strips are made of the same material. In some embodiments with multiple accent strips 20, the accent strips are made of at least two different materials. For example, in some embodiments, one accent strip could be one color and another accent strip could be another color.

In some embodiments, deck clip 10 is configured to evenly space deck boards 30. In some embodiments, multiple deck clips can be attached to each other to allow for wider accent strips 20.

In some embodiments, accent strips 20 can have a concave shape large enough to accommodate conduit.

In some embodiments, deck clip 10 is configured such that wire, such as low voltage wire can be run behind an accent strip. In some such embodiments, accent strips 20 can be used to hide unsightly wires, such as those used for outdoor speakers or landscape lights.

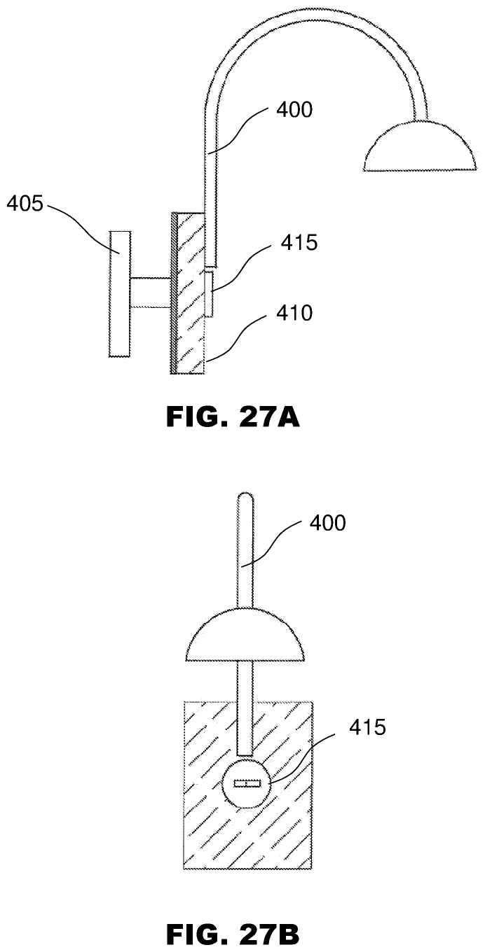

In some embodiments, electrical fixtures, such as light fixture 400 of FIG. 27A and 27B can be incorporated into deck system 100. In some embodiments, light fixture 400 includes light fixture base plate 410.

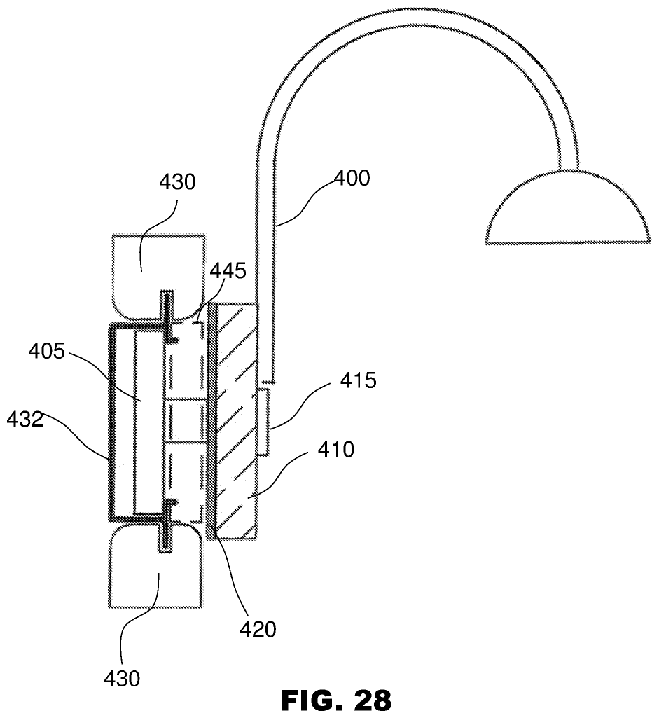

In some embodiments, such as those shown in FIG. 28, light fixture 400 is attached to track strip 432 via locking wing 405. In some embodiments when slotted end cap 415 is turned, locking wing 405 is also turned such that it is held in place by interacting with the lip of track strip 432.

In some embodiments, track strip 432 is placed between deck boards 430 using one of the methods discussed above and below.

In some embodiments, moisture barrier 420 can be used to reduce the likelihood of water infiltrating the electrical wires found in track strip 432. In some embodiments, moisture barrier 420 is a foam gasket.

In some embodiments, lens strip 445 can be used in connection with light fixture 400. In some embodiments, an accent trim strip (such as accent trim strip 40) can be used in connection with light fixture 400. In some such embodiments, accent trim strip 40 and/or lens strip 445 can be used to hide unsightly wires, such as those used for outdoor speakers or landscape lights.

In some embodiments, other electrical fixtures such as, but not limited to, TV screens or speakers can be incorporated into deck system 100 using a method similar to that described above in relationship to light fixture 400.

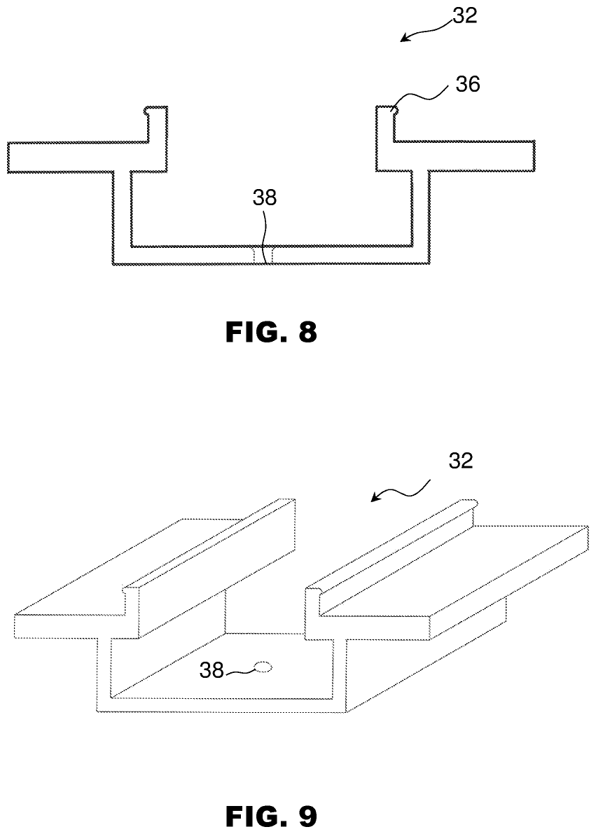

FIG. 8 illustrates another embodiment of incorporating accent trim strips and/or lens strips into a deck system. FIG. 8 shows track strip 32 that can be configured to be placed between two deck boards 30 (see FIGS. 11 and 13). In some embodiments, track strip 32 can include lip 36 to aid in attaching lens strip 45 and/or accent trim strip 40 to track strip 32. In at least some embodiments, track strip 32 runs essentially the length of deck board 30.

In some embodiments, track strip 32 includes screw holes 38 to aid in attaching track strip 32 to a decking system. In some embodiments screw holes 38 are repeated down track strip 32 at a set length. In some embodiments, the set length is approximately 16 inches (40.64 cm) which corresponds to the spacing of the floor joists and/or wall studs used in some decking systems. In some embodiments, the set length is approximately 12 inches (30.48 cm) which corresponds to the spacing of the floor joists and/or wall studs used in some decking systems. In some embodiments the set length is approximately 4 inches (10.16 cm) which can correspond to both 12 inch-spacing and 16 inch-spacing used in various decking systems. In some embodiments, the set length is approximately 1 inch (2.54 cm). In some embodiments, screw holes 38 do not go all the way through the bottom rail of track strip 32 but are instead dimples the can then be drilled through where needed.

In some embodiments, track strip 32 is made, at least in part, of a metal such as aluminum. In some embodiments, track strip 32 is made, at least in part, of a plastic. In some embodiments, the plastic is a polyethylene. In some embodiments, the plastic is a high-density polyethylene.

In some embodiments, multiple track strips 32 can be laid next to each other. For example, one track strip 32 can be configured to incorporate lens strip 45 and light 50, while being sandwiched between two track strips 32 configured to incorporate accent trim strips 40.

In some embodiments, light 50 is a LED light ribbon. In some embodiments, light 50 is an LED strip light. In some embodiments, light 50 is dimmable. In some embodiments, light 50 can change colors. In some embodiments, light 50 can be controlled by a computer. In some embodiments, light 50 can be synchronized with music via a computer.

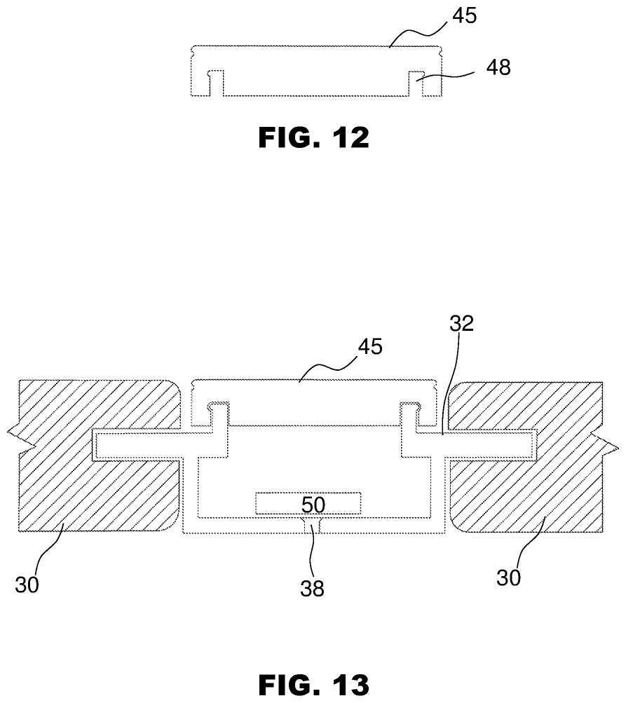

In some embodiments, lens strip 45 is made of acrylic. In some embodiments, such as the one shown in FIG. 12, lens strip 45 has notch 48 configured to interact with lip 36 of track strip 32 to lock lens strip 45 into place. In some embodiments, notch 48 has a radius of approximately 0.0312 inches (0.79 mm). In some embodiments, notch 48 has a radius between 0.02 to 0.04 inches (0.51 mm to 1 mm).

In some embodiments, the deck system incorporates solar panels. In some embodiments, the solar panels can be located in track strip 32 and can be used to energize light 50, thus eliminating, or at least reducing the need of running wire to a conventional power source. In some embodiments, the deck system incorporates a photocell light sensor, such that light 50 can automatically turn on when it gets dark. In some embodiments, the deck system incorporates a motion sensor, such that light 50 can automatically turn on when motion is detected.

In some embodiments, accent trim strip 40 is made of aluminum. In some embodiments, accent trim strip 40 is made of 26-gauge aluminum stock. In some embodiments, accent trim strip 40 is made of, among other materials, vinyl, plastics, polyvinyl chloride, plexiglass, or acrylics.

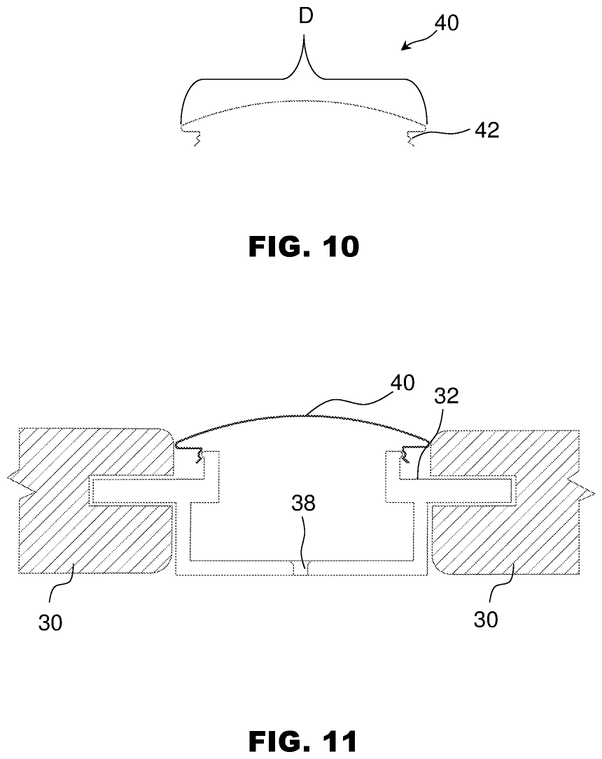

In some embodiments, accent trim strip 40 is lighted. In some embodiments, accent trim strip 40 is made of a semi flexible material that is capable of forming a convex shape such as shown in FIG. 10. In some embodiments, such as the one shown in FIG. 10, accent trim strip 40 has notch 42 configured to interact with lip 36 of track strip 32 to lock accent trim strip 40 into place. In some embodiments, notch 42 has a radius of approximately 0.0312 inches (0.79 mm). In some embodiments, notch 42 has a radius between 0.02 inches to 0.04 inches (0.51 mm to 1 mm).

In some embodiments, accent trim strip 40 has a width D of approximately 1 to 2.5 inches (25.4 to 63.5 mm). In some embodiments, accent trim strip 40 has a width D of approximately 1.75 inches (44.45 mm). In some embodiments, accent trim strip 40 is a phosphorus material, such that it can glow in the dark.

In some embodiments, track strip 32 is configured such that wire, such as low voltage wire can be run behind an accent strip. In some such embodiments, accent trim strip 40 can be used to hide unsightly wires, such as those used for outdoor speakers or landscape lights.

In some embodiments, accent trim strip 40 can have a concave shape large enough to accommodate conduit.

### Deck Anchor Systems(s)

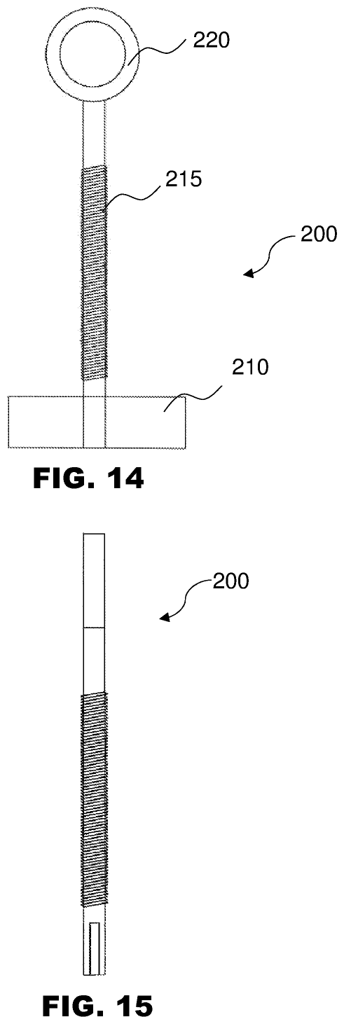

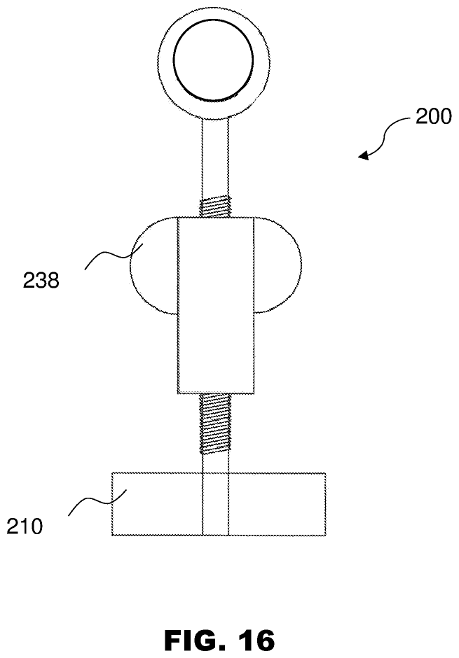

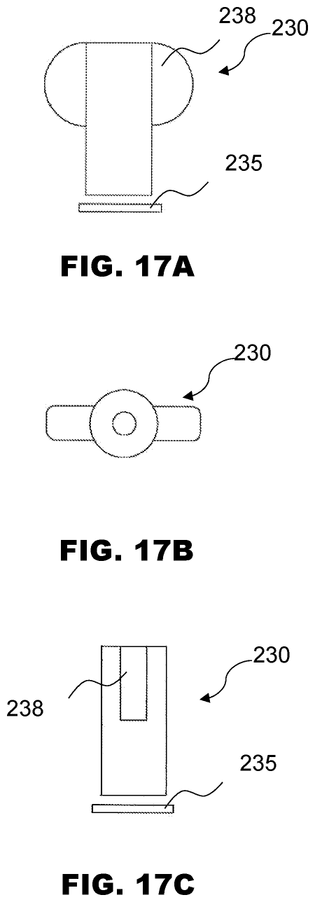

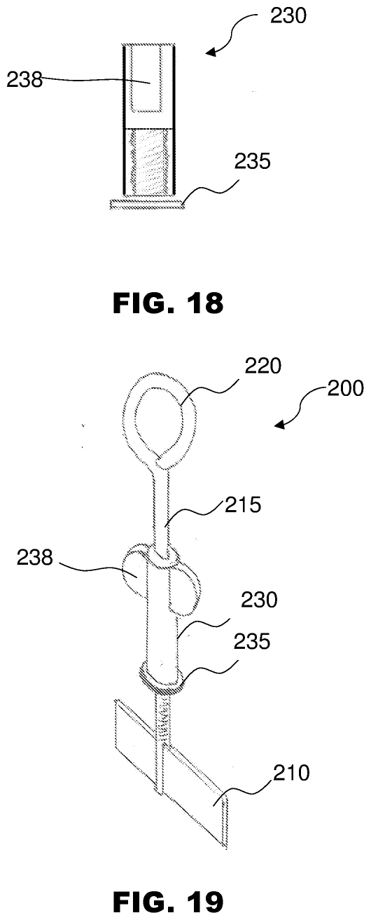

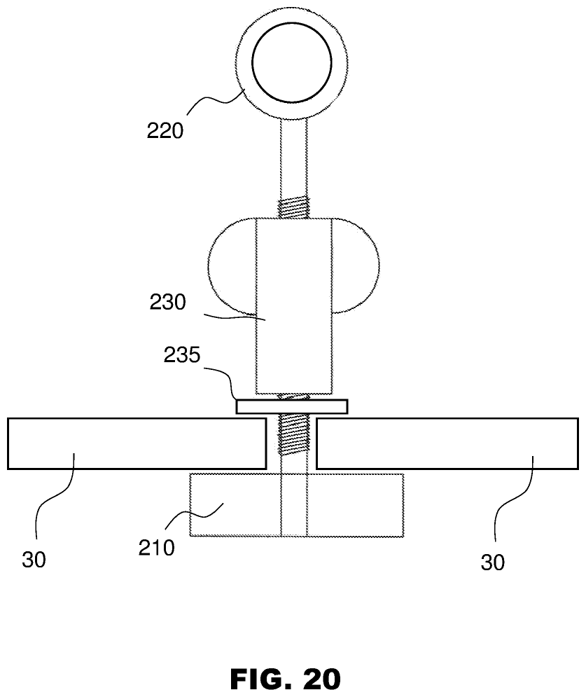

FIG. 14 illustrates deck anchor 200. In some embodiments, deck anchor 200 includes blade 210. In at least some embodiments, blade 210 is configured to be placed into the space between two deck boards, and then turned roughly 90 degrees such that when deck anchor 200 is tightened (such has via handle 230) deck anchor 200 is held in place.

In some embodiments, deck anchor 200 is configured to be used with wood decking. In some embodiments, deck anchor 200 is configured to be used with composite decking. In at least some embodiments, deck anchor 200 requires no tools to be installed. In at least some embodiments, deck anchor 200 can be easily removed and relocated around a deck.

In some embodiments, deck anchor 200 includes a tightening handle 230 between blade 210 and eye hook 220 on shaft 215. In some embodiments, shaft 215 is threaded. In some embodiments, shaft 215 is made of a metal such as, but not limited to, stainless steel or aluminum. In some embodiments, shaft 215 is made of a plastic such as, but not limited to, high-density polyethylene.

In some embodiments, tightening handle 230 is configured to move up and down threads of shaft 215 of deck anchor 200 such that deck anchor 200 can be installed on a deck system. In at least some embodiments, handle 230 is internally threaded to match the threads on shaft 215. In some embodiments, handle 230 has one or more wings 238 to aid in tightening deck anchor. In some embodiments, wing(s) 238 is/are made of a metal such as, but not limited to, stainless steel or aluminum. In some embodiments, wing(s) 238 is/are made of a plastic such as, but not limited to, high-density polyethylene.

In some embodiments, handle 230 includes a tension-based pin that can be pulled out to move handle 230 up and down shaft 215. In some embodiments, shaft 215 can have predetermined holes to receive the pin.

In some embodiments, tightening handle 230 includes disk 235 welded to handle 230. In some embodiments, disk 235 is a separate component. In some embodiments, disk 235 is made of a material configured to protect the deck such as, but not limited to, plastic, Teflon, nylon, and/or other non-marring materials. In some embodiments, disk 235 is metal.

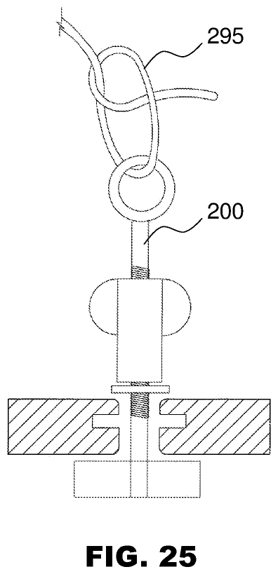

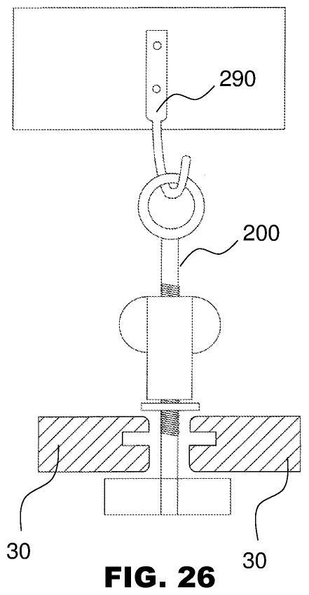

In some embodiments, eye hook 220 opens via a hinge. In some embodiments, eye hook 220 is configured to receive, among other things, ropes, tarps, clevis hooks, carabiner clips and/or bungees. In some embodiments, such as the one depicted in FIG. 26, a corresponding hook 290 can be installed onto a particular item, such as a grill, that can then be connected to deck anchor 200. In some embodiments, such as the one depicted in FIG. 25, rope 295 can be connected to deck anchor 200.

In some embodiments, deck anchor 200 is colored to match the deck.

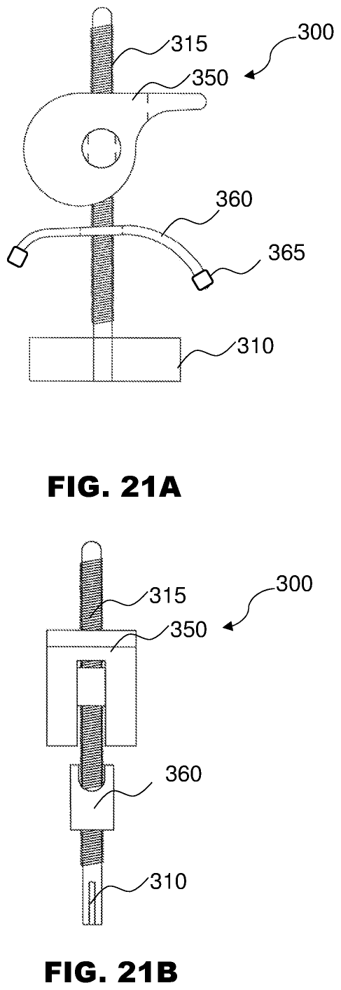

Turning to FIG. 21A and FIG. 21B, deck anchor 300 is shown. In at least some embodiments, deck anchor 300 includes cam lever 350, pinch bar 360, shaft 315, and/or blade 310. In at least some embodiments, blade 310 is configured to be placed in the space between two deck boards, and then turned roughly 90 degrees such that when deck anchor 300 is tightened, blade 310 provides tension to hold deck anchor 300 upright.

In some embodiments, deck anchor 300 includes a disk similar to disk 235. In some embodiments, disk 235 is made of a material configured to protect the deck such as, but not limited to, plastic, Teflon, nylon, and/or other non-marring materials. In some embodiments, the disk is metal.

In some embodiments not shown, deck anchor 300 includes an eye hook. In some embodiments, the eye hook is configured to receive, among other things, ropes, tarps, and/or bungees. In some embodiments, such as the one depicted in FIG. 26, a corresponding hook can be installed onto a particular item, such as a grill, that can then be connected to deck anchor 300.

In some embodiments, pinch bar 360 includes at least one rubber end 365. In some embodiments, pinch bar 360 is dipped in rubber. In some embodiments, pinch bar 360 is magnetic to aid in attaching to furniture and/or grills.

In at least some embodiments, deck anchor 300 can be installed without tools onto a deck and be used to anchor furniture, grills, etc. In at least some embodiments, deck anchor 300 can be easily removed and relocated around a deck.

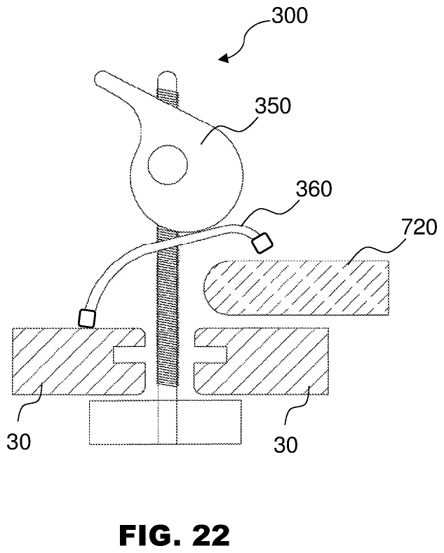

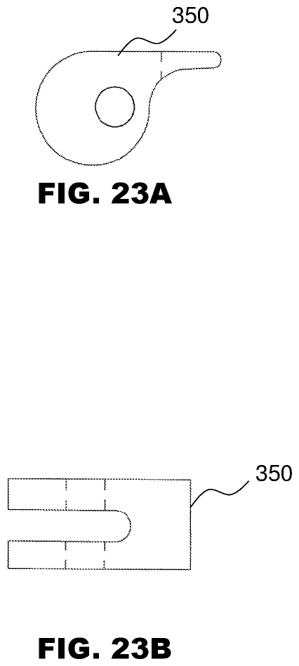

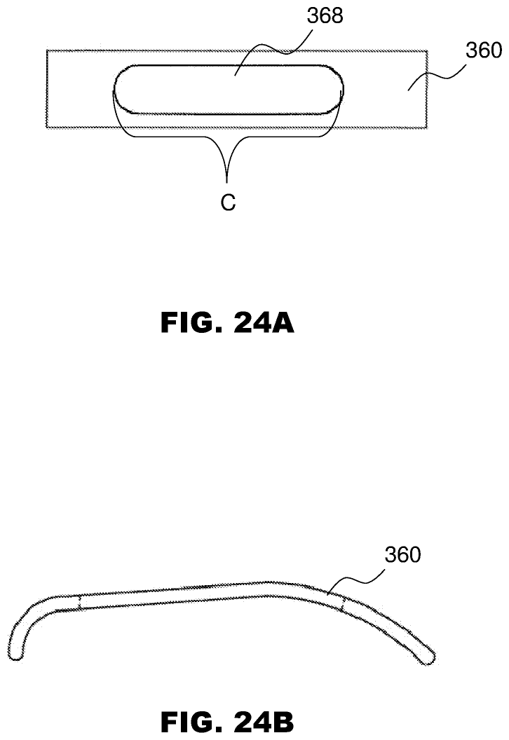

In some embodiments, such as the one shown in FIG. 22, pinch bar 360 is aligned over a piece of furniture (such as bottom rail 720) and then held in place by activating cam lever 350.

In some embodiments, shaft 315 is threaded.

In at least some embodiments, pinch bar 360 has a curved shape. In some embodiments, pinch bar 360 has an elongated center opening 368 to accommodate a variety of furniture and/or grill types. In some embodiments, pinch bar 360 is made of a metal such as, but not limited to, stainless steel or aluminum. In some embodiments, pinch bar 360 is made of a plastic such as, but not limited to, high-density polyethylene. In some embodiments, length C of elongated center opening 368 is about 0.5 inches to 2 inches (1.27 to 5.08 cm).

In at least some embodiments, cam lever 350 provides pressure on pinch bar 360 and, in turn, the piece of furniture/grill being anchored. In some embodiments, cam lever 350 is made of a metal such as, but not limited to, stainless steel or aluminum. In some embodiments, cam lever 350 is made of a plastic such as, but not limited to, high-density polyethylene.

In some embodiments, cam lever 350 is configured to move up and down threads of shaft 315 of deck anchor 300 such that deck anchor 300 can be installed on a deck system. In at least some embodiments, cam lever 350 is internally threaded to match the threads on shaft 315. In some embodiments, cam lever 350 includes a tension-based pin that can be pulled out to move cam lever 350 up and down shaft 315. In some embodiments, shaft 315 can have predetermined holes to receive the pin.

In some embodiments, pinch bar 360 is configured to move up and down threads of shaft 315 of deck anchor 300 such that deck anchor 300 can be installed on a deck system. In at least some embodiments, pinch bar 360 is internally threaded to match the threads on shaft 315. In some embodiments, pinch bar 360 includes a tension-based pin that can be pulled out to move pinch bar 360 up and down shaft 315. In some embodiments, shaft 315 can have predetermined holes to receive the pin.

While particular elements, embodiments and applications of the present invention have been shown and described, it will be understood, that the invention is not limited thereto since modifications can be made without departing from the scope of the present disclosure, particularly in light of the foregoing teachings.

What is claimed is:

1. A deck system comprising:
(a) a first deck board;
(b) a second deck board;
(c) an accent strip; and
(d) a deck clip.

2. The deck system of claim 1 wherein said first deck board and said second deck board are slotted to receive said deck clip.

3. The deck system of claim 1 wherein said deck clip has a hole configured to receive a screw to attach said deck clip to a wall.

4. The deck system of claim 1 wherein said accent strip is made of aluminum.

5. The deck system of claim 1 wherein said accent strip is made of vinyl.

6. The deck system of claim 1 wherein said accent strip incorporates lights.

7. A deck system comprising:
(a) a first deck board;
(b) a second deck board;
(c) a track strip; and
(d) an accent trim strip or a lens strip.

8. The deck system of claim 7 further comprising:
(e) a light fixture.

9. The deck system of claim 8 wherein said light fixture is attached to said deck system via a locking wing interacting with a lip of said track strip.

10. The deck system of claim 7 including said lens strip.

11. The deck system of claim 10 wherein said lens strip incorporates at least one light.

12. A deck anchor system comprising:
(a) a deck anchor.

13. The deck anchor system of claim 12 further comprising:
(b) a bungee cord.

14. The deck anchor system of claim 12 further comprising:
(b) a corresponding hook.

15. The deck anchor system of claim 12 wherein said deck anchor comprises:
(i) a tightening handle;
(ii) a blade;
(iii) an eye hook; and
(iv) a shaft.

16. The deck anchor system of claim 15 wherein said shaft is threaded.

17. The deck anchor system of claim 12 wherein said deck anchor comprises:
(i) a blade;
(ii) a pinch bar;
(iii) a cam lever; and
(iv) a shaft.

18. The deck anchor system of claim 17 wherein said shaft is threaded.

19. The deck anchor system of claim 17 wherein said pinch bar is curved.

20. The deck anchor system of claim 17 wherein an end of said pinch bar is covered in rubber.
